(19) United States
(12) Patent Application Publication
(10) Pub. No.: US 2008/0039546 A1
(43) Pub. Date: Feb. 14, 2008

(54) Photocurable Composition and Optical Part

(76) Inventors: Satoshi Futami, Tokyo (JP); Ken Komiya, Tokyo (JP)

Correspondence Address: MAYER BROWN LLP, P.O. BOX 2828, CHICAGO, IL, 60690, US

(21) Appl. No.: 10/599,527

(22) PCT Filed: Mar. 15, 2005
(86) PCT No.: PCT/NL05/00195

§ 371 Date: Aug. 6, 2007

(30) Foreign Application Priority Data
Mar. 30, 2004 (JP) 2004-97737

(51) Int. Cl. C09D 4/00; G02B 1/00

(52) U.S. Cl. 522/182

(57) ABSTRACT

Subject: To provide a photocurable composition capable of producing a cured product excelling in heat resistance, showing only a small amount of deformation, and producing cured products particularly useful as optical parts. Means for the Solution: A photocurable composition comprising the following components (A)-(D): (A) at least one of the (meth)acrylates having the structures shown by the formulas (1) and (2) (excluding the following component (C)), Chemical Formula (1), Chemical Formula (2) wherein R¹ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—, (B) a (meth)acrylate having three or more functional groups, (C) a monofunctional monomer of which the homopolymer has a Tg of 150° C. or more, and (D) a radical photoinitiator, wherein 5-50 wt % of the total acrylic components in the composition is a methacrylate compound and the component (C) is contained in an amount of 4-40 wt %.

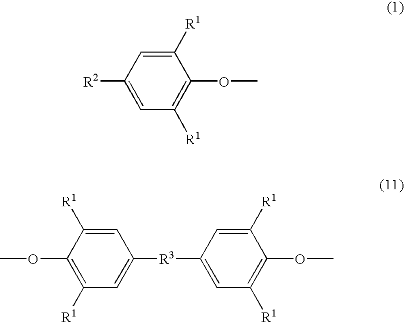

### TECHNICAL FIELD

The present invention relates to a photocurable composition. More particularly, the present invention relates to a photocurable composition useful for forming an optical part such as a lens of a prism lens sheet used for a backlight of a liquid crystal display and a Fresnel lens sheet or a lenticular lens sheet used for a screen of a projection TV or a backlight using such a sheet.

### BACKGROUND ART

Conventionally, lenses such as a Fresnel lens and a lenticular lens are manufactured by using a press-forming process or a casting process. However, these processes require a long period of time for manufacturing the lens, thereby resulting in poor productivity. In order to solve this problem, a method of manufacturing lenses using a UV-curable resin has been studied in recent years. In more detail, the method comprises casting a UV-curable resin composition into the space between a mold having a lens shape and a transparent resin substrate and curing the composition by applying ultraviolet rays from the side of the substrate, whereby a lens can be manufactured in a short period of time.

However, in the case of using a hard lens sheet in recent years, the sheet may be warped during production or the lens shape may be deformed when the lens sheet used at a high temperature of about 60° C. is cooled to room temperature depending on the use conditions. As a result, distortion may occur in the resulting image. Therefore, a technology for producing a lens sheet with low curling properties by using a large amount of monofunctional monomers instead of polyfunctional monomers in a resin has been proposed (Japanese Patent Application Laid-open No. 2004-51941). However, this technology decreases the degree of crosslinking of the product due to reduction in the amount of polyfunctional monomers, which results in poor heat resistance.

### DISCLOSURE OF THE INVENTION

### Problems to be Solved by the Invention

Accordingly, an object of the present invention is to provide a photocurable composition capable of producing a cured product excelling in heat resistance, showing only a small amount of deformation, and producing cured products particularly useful as optical parts.

### Means for Solving the Problem

As a result of extensive studies, the present inventors have found that low curling properties and high heat resistance can be achieved by using a specific composition. This finding has led to the completion of the present invention.

Specifically, the present invention provides a photocurable composition comprising the following components (A)-(D):
(A) at least one of the (meth)acrylates having the structures shown by the formulas (1) and (2) (excluding the following component (C)), 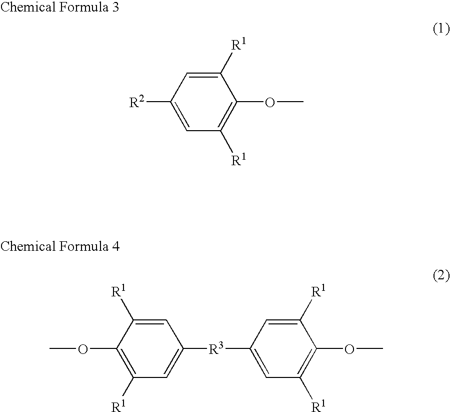
   wherein R¹ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C(CH₃)₂—,
(B) a (meth)acrylate having three or more functional groups,
(C) a monofunctional monomer of which the homopolymer has a Tg of 150° C. or more, and
(D) a radical photoinitiator,
   wherein 5-50 wt % of the total acrylic components in the composition is a methacrylate compound and the component (C) is contained in an amount of 4-40 wt %, and an optical part obtained by curing the photocurable composition.

### EFFECT OF THE INVENTION

According to the present invention, a photocurable composition capable of producing a cured product having excellent heat resistance and low curling properties can be obtained. In particular, low curling properties and high heat resistance of the cured product can be achieved when the composition contains a monofunctional monomer of which the homopolymer has a high Tg.

### BEST MODE FOR CARRYING OUT THE PRESENT INVENTION

The component (A) used in the present invention is at least one of the (meth)acrylates having the structures shown by the formulas (1) or (2), provided that the component (A) does not include the component (C).

As examples of the halogen atom other than a fluorine atom represented by R¹ in the formulas (1) and (2), a chlorine atom, bromine atom, and iodine atom can be given. Of these, a bromine atom is preferable.

As the (meth)acrylate having the structure shown by the formula (1), a compound shown by the following formula (3) is preferable: 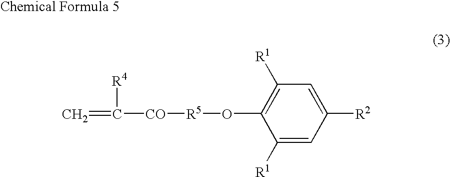
wherein R⁴ represents a hydrogen atom or a methyl group, R⁵ represents —(OCH₂CH₂)ₘ—, —(OCH₂CH(CH₃))ₙ—, or —OCH₂CH(OH)CH₂—, m and n individually represent an integer from 0 to 10, and R¹ and R² are the same as defined above.

As the (meth)acrylate having the structure shown by the formula (2), a compound shown by the following formula (4) is preferable. 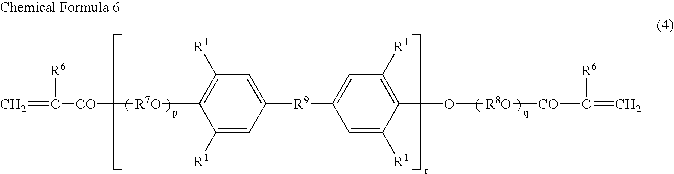
wherein R⁶ represents a hydrogen atom or a methyl group, R⁷ and R⁸ represent —CH₂CH₂—, —CH₂CH(CH₃)—, or —CH₂CH(OH)CH₂—, R⁹ represents —CH₂—, —S—, or —C(CH₃)₂—, p, q, and r are individually an integer from 0 to 10, and R¹ is the same as defined above.

As examples of the (meth)acrylate having the structure shown by the formula (1) of the component (A), phenoxyethyl(meth)acrylate, phenoxy-2-methylethyl(meth)acrylate, phenoxyethoxyethyl(meth)acrylate, 3-phenoxy-2-hydroxypropyl(meth)acrylate, 2-phenylphenoxyethyl(meth)acrylate, 4-phenylphenoxyethyl(meth)acrylate, 3-(2-phenylphenyl)-2-hydroxypropyl(meth)acrylate, (meth)acrylate of p-cumylphenol which is reacted with ethylene oxide, 2-bromophenoxyethyl(meth)acrylate, 4-bromophenoxyethyl(meth)acrylate, 2,4-dibromophenoxyethyl(meth)acrylate, 2,6-dibromophenoxyethyl(meth)acrylate, 2,4,6-tribromophenyl(meth)acrylate, 2,4,6-tribromophenoxyethyl(meth)acrylate, and the like can be given. Of these, phenoxyethyl(meth)acrylate, phenoxyethoxyethyl(meth)acrylate, (meth)acrylate of p-cumylphenol reacted with ethylene oxide, 2,4,6-tribromophenoxyethyl(meth)acrylate, and the like are particularly preferable.

As examples of the (meth)acrylate having the structure shown by the formula (2) of the component (A), ethylene oxide addition bisphenol A (meth)acrylate, ethylene oxide addition tetrabromobisphenol A (meth)acrylate, propylene oxide addition bisphenol A (meth)acrylate, propylene oxide addition tetrabromobisphenol A (meth)acrylate, bisphenol A epoxy (meth)acrylate obtained by an epoxy ring-opening reaction of bisphenol A diglycidyl ether with (meth)acrylic acid, tetrabromobisphenol A epoxy (meth)acrylate obtained by an epoxy ring-opening reaction of tetrabromobisphenol A diglycidyl ether with (meth)acrylic acid, bisphenol F epoxy (meth)acrylate obtained by an epoxy ring-opening reaction of bisphenol F diglycidyl ether with (meth)acrylic acid, tetrabromobisphenol F epoxy (meth)acrylate obtained by an epoxy ring-opening reaction of tetrabromobisphenol F diglycidyl ether with (meth)acrylic acid, and the like can be given. Of these, ethylene oxide addition bisphenol A (meth)acrylate, ethylene oxide addition tetrabromobisphenol A (meth)acrylate, bisphenol A epoxy (meth)acrylate obtained by an epoxy ring-opening reaction of bisphenol A diglycidyl ether with (meth)acrylic acid, tetrabromobisphenol A epoxy (meth)acrylate, and the like are particularly preferable.

As examples of commercially available products of the (meth)acrylate having the structure shown by the formula (1), Aronix M113, M110, M101, M102, M5700, TO-1317 (manufactured by Toagosei Co., Ltd.), Viscoat #192, #193, #220, 3BM (manufactured by Osaka Organic Chemical Industry Co., Ltd.), NK Ester AMP-10G, AMP-20G (manufactured by Shin-Nakamura Chemical Co., Ltd.), Light Acrylate PO-A, P-200A, Epoxy Ester M-600A, Light Ester PO (manufactured by Kyoeisha Chemical Co., Ltd.), New Frontier PHE, CEA, PHE-2, BR-30, BR-31, BR-31M, BR-32 (manufactured by Daiichi Kogyo Seiyaku Co., Ltd.), and the like can be given.

As examples of commercially available products of the (meth)acrylate having the structure shown by the formula (2), Viscoat #700, #540 (manufactured by Osaka Organic Chemical Industry Co., Ltd.), Aronix M-208, M210 (manufactured by Toagosei Co., Ltd.), NK Ester BPE-100, BPE-200, BPE-500, A-BPE-4 (manufactured by Shin-Nakamura Chemical Co., Ltd.), Light Ester BP-4EA, BP-4PA, Epoxy Ester 3002M, 3002A, 3000M ,3000A (manufactured by Kyoeisha Chemical Co., Ltd.), Kayarad R-551, R-712 (manufactured by Nippon Kayaku Co., Ltd.), BPE-4, BPE-10, BR-42M (manufactured by Daiichi Kogyo Seiyaku Co., Ltd.), Ripoxy VR-77, VR-60, VR-90, SP-1506, SP-1507, SP-1509, SP-1563 (manufactured by Showa Highpolymer Co., Ltd.), Neopole V779, Neopole V779MA (manufactured by Japan U-PiCA Co., Ltd.), and the like can be given.

The component (A) may be used either individually or in combination of two or more.

The content of the component (A) in the total composition is preferably 40-90 wt %, and particularly preferably 50-80 wt %. The above lower limit of the amount is preferable in view of the refractive index. The above upper limit of the amount is preferable in view of viscosity and heat resistance of the cured product.

The component (B) is a (meth)acrylate having three or more functional groups. As examples of the (meth)acrylate used as the component (B), (meth)acrylates of a polyvalent alcohol having a valence of three or more such as trimethylolpropane tri(meth)acrylate, pentaerythritol tri(meth)acrylate, trimethylolpropane trioxyethyl(meth)acrylate, and tris(2-acryloyloxyethyl)isocyanurate, and the like can be given. These compounds may be used either individually or in combination of two or more.

As examples of commercially available products of these compounds, Aronix M305, M309, M 310, M 315, M 320, M350, M360, M408 (manufactured by Toagosei Co., Ltd.), Viscoat #295, #300, #360, GPT, 3PA, #400 (manufactured by Osaka Organic Chemical Industry Co., Ltd.), NK Ester TMPT, A-TMPT, A-TMM-3, A-TMM-3L, A-TMMT (manufactured by Shin-Nakamura Chemical Co., Ltd.), Light Acrylate TMP-A, TMP-6EO-3A, PE-3A, PE-4A, DPE-6A (manufactured by Kyoeisha Chemical Co., Ltd.), Kayarad PET-30, GPO-303, TMPTA, TPA-320, DPHA, D-310, DPCA-20, DPCA-60 (manufactured by Nippon Kayaku Co., Ltd.), and the like can be given.

The content of the component (B) in the total composition is preferably 5-15 wt %, and particularly preferably 5-10 wt %. The above lower limit of the amount is preferable in view of heat resistance of the cured product. The above upper limit of the amount is preferable in view of preventing a decrease in the refractive index.

The component (C) used in the photocurable resin composition of the present invention is a monofunctional monomer of which the homopolymer has a Tg of 150° C. or more, preferably 170° C. or more. The Tg of the component (C) is measured by differential scanning calorimetry (DSC).

As specific examples of the component (C), vinyl caprolactam (Tg: 178° C.), vinyl pyrrolidone (Tg: 175° C.), and the like can be given.

As commercially available products, V-CAP (manufactured by ISP Japan, Ltd.), IBXA (manufactured by Osaka Organic Chemical Industry, Ltd.), Sartomer SR423 (manufactured by Kayaku Sartomer Co., Ltd.), ACMO (manufactured by KOHJIN Co., Ltd.), and the like can be given.

The content of the component (C) in the total composition is usually 4-40 wt %, preferably 5-40 wt %, and particularly preferably 10-30 wt %. The above lower limit of the amount is preferable in view of curling resistance and heat resistance of the cured product. The amount not exceeding the above upper limit is preferable in view of coatability (viscosity).

The component (D) is a radical photoinitiator. As examples of the radical photoinitiator, acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyl diphenylphosphine oxide, bis-(2,6-dimethoxybenzoyl)-2,4,4-trimethylpentylphosphine oxide, initiators with a chemical structure shown by the following formula (5), and the like can be given. 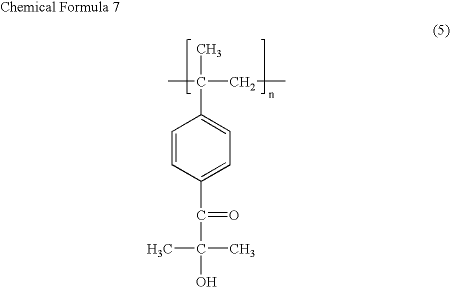
wherein n is an integer of 1-5.

As examples of commercially available products of the radical photoinitiator, Irgacure 184, 369, 651, 500, 819, 907, 784, 2959, CGI1700, CGI1750, CG 111850, CG24-61, Darocure 116, 1173 (manufactured by Ciba Specialty Chemicals Co., Ltd.), Lucirin LR8728 (manufactured by BASF), Ubecryl P36 (manufactured by UCB), KIP150 (manufactured by Lamberti Co.), and the like can be given. Among these, Irgacure184 and KIP150 are preferable, with KIP150 being particularly preferable to improve heat resistance and reduce warping.

The content of the component (D) in the total composition is preferably 0.01-10 wt %, and particularly preferably 0.5-7 wt %. The above upper limit of the amount is preferable in view of ensuring cure characteristics of the composition, mechanical characteristics and optical characteristics of the cured product, handling capability, and the like. The above lower limit of the amount is preferable for preventing a decrease in the cure speed.

The composition of the present invention may further include a photosensitizer. As examples of the photosensitizer, triethylamine, diethylamine, N-methyldiethanoleamine, ethanolamine, 4-dimethylaminobenzoic acid, methyl 4-dimethylaminobenzoate, ethyl 4-dimethylaminobenzoate, isoamyl 4-dimethylaminobenzoate, and the like can be given. As commercially available products of the photosensitizer, Ubecryl P102, 103, 104, and 105 (manufactured by UCB), and the like can be given.

In the present invention, a compound having a (meth)acryloyl group or a vinyl group other than the components (A) to (D) may be used as an optional component (hereinafter called “unsaturated monomer”). As the unsaturated monomer, N-vinylpyrrolidone, vinylimidazole, and vinylpyridine, isobornyl(meth)acrylate, bornyl(meth)acrylate, tricyclodecanyl(meth)acrylate, dicyclopentanyl(meth)acrylate, dicyclopentenyl(meth)acrylate, cyclohexyl(meth)acrylate, benzyl(meth)acrylate, 4-butylcyclohexyl(meth)acrylate, 2-hydroxyethyl(meth)acrylate, acryloylmorpholine, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethylene glycol(meth)acrylate, polyethylene glycol mono(meth)acrylate, polypropylene glycol mono(meth)acrylate, methoxyethylene glycol(meth)acrylate, ethoxyethyl(meth)acrylate, methoxypolyethylene glycol(meth)acrylate, methoxypolypropylene glycol(meth)acrylate, diacetone(meth)acrylamide, isobutoxymethyl(meth)acrylamide, N,N-dimethyl(meth)acrylamide, t-octyl(meth)acrylamide, dimethylaminoethyl(meth)acrylate, diethylaminoethyl(meth)acrylate, 7-amino-3,7-dimethyloctyl(meth)acrylate, N,N-diethyl(meth)acrylamide, N,N-dimethylaminopropyl(meth)acrylamide, hydroxybutyl vinyl ether, lauryl vinyl ether, cetyl vinyl ether, 2-ethylhexyl vinyl ether, and monofunctional monomers shown by following formulas (6) and (7) can be given: 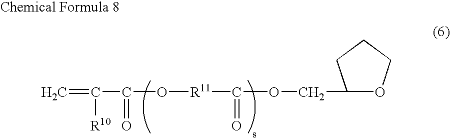
wherein R¹⁰ represents a hydrogen atom or a methyl group, R¹¹ represents an alkylene group having 2-8 carbon atoms, and s is an integer from 1 to 8; 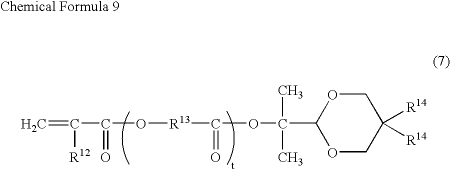
wherein R¹² and R¹⁴ individually represent a hydrogen atom or a methyl group, R¹³ represents an alkylene group having 2 to 8 carbon atoms, and t is an integer from 1 to 8.

Further examples include unsaturated monomers having two (meth)acryloyl groups or two vinyl groups in the molecules such as an alkyldiol diacrylate such as 1,4-butanediol diacrylate, 1,6-hexanediol diacrylate, and 1,9-nonanediol diacrylate, polyalkylene glycol diacrylate such as ethylene glycol di(meth)acrylate, tetraethylene glycol diacrylate, and tripropylene glycol diacrylate, neopentyl glycol di(meth)acrylate, and tricyclodecanemethanol diacrylate.

Among the above unsaturated monomers, acrylic monomers of which the homopolymer has a Tg of 35° C. or less are preferably not contained in the composition of the present invention. Therefore particularly preferable unsaturated monomers are acryloylmorpholine, N-vinylpyrrolidone, 1,6-hexanedioldiacrylate, and the like.

The composition of the present invention may further include a urethane(meth)acrylate oligomer. As examples of the urethane(meth)acrylate, polyether polyols such as polyethylene glycol and polytetramethyl glycol; polyester polyols obtained by the reaction of a dibasic acid such as succinic acid, adipic acid, azelaic acid, sebacic acid, phthalic acid, tetrahydrophthalic acid (anhydride), hexahydrophthalic acid (anhydride) with a diol such as ethylene glycol, propylene glycol, diethylene glycol, triethylene glycol, tetraethylene glycol, dipropylene glycol, 1,4-butanediol, 1,6-hexanediol, and neopentyl glycol; poly ε-caprolactone-modified polyol; polymethylvalerolactone-modified polyol; ethylene glycol, propylene glycol, 1,4-butanediol, and 1,6-hexanediol; alkyl polyols such as neopentyl glycol; bisphenol A skeleton alkylene oxide modified polyols such as ethylene oxide addition bisphenol A and propylene oxide addition bisphenol A; bisphenol F skeleton alkylene oxide modified polyols such as ethylene oxide addition bisphenol F and propylene oxide addition bisphenol F; urethane(meth)acrylate oligomers prepared from a mixture of these, an organic polyisocyanate such as tolylene diisocyanate, isophorone diisocyanate, hexamethylene diisocyanate, diphenylmethane diisocyanate, and xylylene diisocyanate, and a hydroxyl group-containing (meth)acrylate such as 2-hydroxyethyl(meth)acrylate and 2-hydroxypropyl(meth)acrylate; and the like can be given. Use of the urethane(meth)acrylate oligomer is preferable in order to maintain the viscosity of the curable composition of the present invention at a moderate level.

The urethane(meth)acrylate oligomer is used in the curable composition of the present invention in an amount of preferably 4.99-40 wt %, and still more preferably 4.99-20 wt %.

As examples of commercially available products of monomers of the urethane(meth)acrylate oligomer, Aronix M 120, M-150, M-156, M-215, M-220, M-225, M-240, M-245, M-270 (manufactured by Toagosei Co., Ltd.), AIB, TBA, LA, LTA, STA, Viscoat#155, IBXA, #158, #190, #150, #320, HEA, HPA, #2000, #2100, DMA, #195, #230, #260, #215, #335HP, #310HP, #310HG, #312 (manufactured by Osaka Organic Chemical Industry Co., Ltd.), Light Acrylate IAA, L-A, S-A, BO-A, EC-A, MTG-A, DMP-A, THF-A, IB-XA, HOA, HOP-A, HOA-MPL, HOA-MPE, 3EG-A, 4EG-A, 9EG-A, NP-A, 1,6HX-A, DCP-A (manufactured by Kyoeisha Chemical Co., Ltd.), Kayarad TC-110S, HDDA, NPGDA, TPGDA, PEG400DA, MANDA, HX-220, HX-620 (manufactured by Nippon Kayaku Co., Ltd.), FA-511A, 512A, 513A (manufactured by Hitachi Chemical Co., Ltd.), VP (manufactured by BASF), ACMO, DMAA, DMAPAA (manufactured by Kohjin Co., Ltd.), and the like can be given.

The urethane(meth)acrylate oligomer is obtained as a reaction product of (a) a hydroxyl group-containing (meth)acrylate, (b) an organic polyisocyanate, and (c) a polyol. The urethane(meth)acrylate oligomer is preferably a reaction product obtained by reacting the hydroxyl group-containing (meth)acrylate (a) with the organic polyisocyanate (b), and reacting the resulting product with the polyol (c).

The curable composition of the present invention contains the methacrylate compound in an amount of 5-50 wt %, preferably 10-40 wt %, and still more preferably 15-40 wt % of the total acrylic components in the composition. If the content of the methacrylate compound is 5 wt % or more, heat resistance is increased. If the content is 50 wt % or less, warping during curing is prevented. The total acrylic components refer to the total amount of the acrylate compound and the methacrylate compound. The total acrylic components herein include urethane acrylate oligomers, but exclude vinyl monomers and urethane methacrylate oligomers among unsaturated monomers.

In addition to the above components, additives such as antioxidants, UV absorbers, light stabilizers, silane coupling agents, coating surface improvers, heat-polymerization inhibitors, leveling agents, surfactants, coloring agents, preservatives, plasticizers, lubricants, solvents, fillers, aging preventives, wettability improvers, and release agents may optionally be added.

Examples of antioxidants include Irganox1010, 1035, 1076, 1222 (manufactured by Ciba Specialty Chemicals Co., Ltd.), Antigen P, 3C, FR, Sumilizer GA-80 (manufactured by Sumitomo Chemical Industries Co., Ltd.), and the like; examples of UV absorbers include Tinuvin P, 234, 320, 326, 327, 328, 329, 213 (manufactured by Ciba Specialty Chemicals Co., Ltd.), Seesorb 102, 103, 110, 501, 202, 712, 704 (manufactured by Sypro Chemical Co., Ltd.), and the like; examples of light stabilizers include Tinuvin 292, 144, 622LD (manufactured by Ciba Specialty Chemicals Co., Ltd.), Sanol LS770 (manufactured by Sankyo Co., Ltd.), Sumisorb TM-061 (manufactured by Sumitomo Chemical Industries Co., Ltd.), and the like; examples of silane coupling agents include γ-aminopropyltriethoxysilane, γ-mercaptopropyltrimethoxysilane, and γ-methacryloxypropyltrimethoxysilane, and commercially available products such as SH6062, SH6030 (manufactured by Toray-Dow Corning Silicone Co., Ltd.), and KBE903, KBE603, KBE403 (manufactured by Shin-Etsu Chemical Co., Ltd.); examples of coating surface improvers include silicone additives such as dimethylsiloxane polyether and commercially available products such as DC-57, DC-190 (manufactured by Dow-Corning), SH-28PA, SH-29PA, SH-30PA, SH-190 (manufactured by Toray-Dow Corning Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.). As a mold releasing agent, PRISURF A208F (manufactured by Daiichi Kogyo Seiyaku Co., Ltd.) and the like can be given.

The composition of the present invention may be prepared by mixing the above components using a conventional method. Viscosity of the composition of the present invention prepared in this manner is usually 200-50,000 cp/25° C., and preferably 500-30,000 cp/25° C. If the viscosity of the composition is too great, coating may become uneven or swelling may occur when forming a lens, or a desired thickness of the lens may not be obtained, whereby performance of the lens may be insufficient. If the viscosity is too low, it is difficult to control the thickness of the lens, whereby a lens having a uniform thickness may not be formed.

It is particularly preferable that a cured product obtained by curing the composition of the present invention with radiation have the following properties. The refractive index of the cured product at 25° C. is preferably 1.55 or more, and still more preferably 1.56 or more. If the refractive index is less than 1.55, sufficient frontal brightness may not be secured when forming a prism lens sheet using the composition of the present invention.

The softening point of the cured product is preferably 40° C. or more, and particularly preferably 50° C. or more. If the softening point of the cured product is less than 40° C., heat resistance may be insufficient.

### EXAMPLES

The present invention is described below in more detail by examples. However, the present invention is not limited to these examples.

### Example 1 and Comparative Examples 1-5

A reaction vessel was charged with the components shown in Table 1. The mixture was stirred at 50-60° C. for one hour to obtain a curable liquid composition having a viscosity of 500-10,000 cps/25° C. The unit of each component shown in Table 1 is “part by weight”.

Various components shown in Table 1 are as follows.

Component (A)

Tetrabromobisphenol A epoxy acrylate: Neopole V779 (manufactured by Japan U-PiCA Co., Ltd.)
Phenoxyethyl methacrylate: Light Ester PO (manufactured by Kyoeisha Chemical Co., Ltd.)
Tribromophenoxyethyl acrylate: New Frontier BR-31 (manufactured by Daiichi Kogyo Seiyaku Co., Ltd.)
Bisphenol A epoxy acrylate: Ripoxy VR-90 (manufactured by Showa Highpolymer Co., Ltd.)
   Component (B)
Tris(acryloylethyl) isocyanurate: Aronix M315 (manufactured by Toagosei Co., Ltd.)
   Component (C)
Vinyl caprolactam: V-CAP (manufactured by ISP Japan, Ltd.) (Tg; 176° C.)

Tg was measured from the inflection point of a thermal expansion curve obtained by heating a sample at a rate of 20° C./min using a differential scanning calorimeter (Thermo Plus DSC8230) manufactured by Rigaku Corp.

Component (D)

1-Hydroxy-cyclohexyl phenyl ketone: Irgacure 184 (manufactured by Ciba Specialty Chemicals Co., Ltd.)
Initiator of the formula (5): KIP150 (manufactured by Lamberti Co., Ltd.)
   Other Components
Acryloylmorpholine: ACMO manufactured by KOHJIN Co., Ltd. (Tg: 145° C.)
1,9-Nonanediol diacrylate: New Frontier LC-9A (Tg: 31° C.) (manufactured by Daiichi Kogyo Seiyaku Co., Ltd.)
Urethane acrylate (Tg: 103° C.) was synthesized by the following method.

A reaction vessel equipped with a stirrer was charged with 35.47 wt % of 2,4-tolylene diisocyanate, 0.08 wt % of di-n-butyltin dilaurata, and 0.02 wt % of 2,6-di-t-butyl-p-cresol. 23.65 wt % of 2-hydroxyethyl acrylate was added dropwise while stirring so as to maintain the temperature at 30° C. or lower. After the addition, the mixture was allowed to react at 30° C. for one hour. After the addition of 40.77 wt % of bisphenol A ethylene oxide addition diol (number of ethylene oxide structural units=4; average molecular weight=400), the mixture was allowed to react at 50-70° C. for two hours. The reaction was terminated when the residual isocyanate was 0.1 wt % or less.

Evaluation Method

1. Measurement of Refractive Index

The curable liquid composition was applied onto a glass plate using an applicator bar and irradiated with ultraviolet rays at a dose of 1.0 J/cm² under air atmosphere to obtain a cured film with a thickness of 200 μm. The refractive index of the cured film at 25° C. was measured using an Abbe refractometer manufactured by Atago Co., Ltd. according to JIS K7105.

2. Evaluation of Transparency

The curable liquid composition was applied to a polyethyleneterephthalate (PET) film with a thickness of 125 μm by using an applicator bar to a thickness of 40 μm. The composition was exposed to ultraviolet rays at a dose of 250 mJ/cm² in nitrogen atmosphere to obtain a cured film. Transparency of the resulting cured film was visually observed to evaluate the presence or absence of abnormalities such as foreign matters, coating unevenness, repelled matters, white turbidity, loss of clarity, and the like. The samples not exhibiting any of these abnormalities were rated as “∘”, otherwise the samples were rated as “×”.

3. Evaluation of Heat Resistance

Cured films were obtained in the same manner as in the transparency evaluation. The sample was cut into a square of 1 cm×1 cm A column-shaped quartz stick with a diameter of 5 mmφ was pressed against the test specimen at a load of 20 gf using a thermal mechanical analysis (TMA) system (manufactured by Seiko Instruments Inc.) while changing the temperature to measure the amount of displacement of the thickness of the test specimen. The temperature increase rate was 5° C./min. The amount of displacement increases as the temperature increases. The inflection point at which the amount of displacement decreases was measured as the softening point. If the inflection point is lower than 50° C., when forming a lens sheet using the curable composition of the present invention, the shape of the lens may deform at a high temperature. Therefore, the case where the inflection point was lower than 40° C. was judged as “××”, the case where the inflection point was lower than 50° C. was judged as “×”, the case where the inflection point was 50° C. or more was judged as “∘”, and the case where the inflection point was 60° C. or more was judged as “●”. The above softening point was regarded as the heat resistant temperature.

The measurement was performed after heating the cured film at 60° C. for three days immediately after irradiation with ultraviolet rays.

4. Measurement of Warping

Cured films were obtained in the same manner as in the transparency evaluation. The sample was cut into a square of 8 cm×8 cm and placed on a flat desk with the cured film on the upper side. The height of the four corners of the sample from the desk was measured. The average value of the height was defined as the amount of warping. If the amount of warping exceeds 20 mm, when forming a lens sheet using the curable composition of the present invention, optical characteristics such as brightness may be impaired due to curling of the lens. Therefore, a case where the amount of warping exceeded 20 mm was judged as “×”, and a case where the amount of warping was 20 mm or less was judged as “∘”, and a case where the amount of warping was 10 mm or less was judged as “●”.

The measurement was performed after heating the cured film at 60° C. for three days immediately after irradiation with ultraviolet rays, and reheating the cured film at 85° C. for 30 minutes.

(5) Evaluation of Coatability

Curable liquid compositions easily coated were rated as “∘”, otherwise as “×”.

The results are shown in Table 1.

TABLE 1

| | | Example | Comparative Example | | | | |
|---|---|---|---|---|---|---|---|
| Component | | 1 | 1 | 2 | 3 | 4 | 5 |
| (A) | Neopole V779 | | 31 | | 20 | | 31 |
| | Light Ester PO | 17 | 15.5 | 17 | 17 | 17 | 6 |
| | New Frontier BR-31 | 18 | 17 | 17 | 18 | 13 | 17 |
| | Ripoxy VR-90 | 24 | 10 | 24 | 24 | | 10 |
| (B) | Aronix M315 | 8 | 5.5 | 8 | 8 | 10 | 45 |
| (C) | Vinyl caprolactam | 20 | | | | 45 | |
| (D) | Irgacure 184 | | 3 | | | | 3 |
| | KIP 150 | 3 | | 3 | 3 | 3 | |
| Others | 1,9-nonanediol diacrylate | | 5 | 20 | | | 5 |
| | Urethane acrylate | 10 | | 10 | 10 | | |
| | Acryloyl morpholine | 3 | 16 | 4 | 3 | 15 | |
| Methacrylate compounds in the total of | | 17 | 15.5 | 17 | 17 | 17 | 4.6 |
| the acryl components (wt %) | | | | | | | |
| Properties | Refractive Index | 1.57 | 1.57 | 1.57 | 1.57 | 1.55 | 1.57 |
| of the cured | Transparency | ◯ | ◯ | ◯ | ◯ | ◯ | ◯ |
| product | Heat resistance: | | | | | | |
| | After UV irradiation | ◯ | ◯ | X | ◯ | ● | ◯ |
| | After heating | ● | ◯ | XX | ● | ● | ◯ |
| | Heat resistant temperature | 58 | 51 | 40 | 57 | 65 | 50 |
| | after heating | | | | | | |
| | Warping: | | | | | | |
| | After UV irradiation | ● | ● | ◯ | X | ● | X |
| | After heating | ● | ● | ● | X | ● | X |
| Property of | Coatability (viscosity) | ◯ | ◯ | ◯ | ◯ | X | ◯ |
| the liquid | | | | | | | |
| product | | | | | | | |

As is clear from Table 1, the cured product of the composition of the present invention containing the components (A), (B), (C), and (D) excels in heat resistance, shows a small amount of warping and deformation, and has a refractive index as high as 1.55 or more. Therefore, the cured product is particularly useful as an optical part.

### INDUSTRIAL APPLICABILITY

The cured product obtained from the photocurable composition of the present invention excels in heat resistance and shows a small amount of deformation while maintaining a high refractive index. Therefore, the cured product is particularly useful as an optical part such as a prism lens sheet.

1. A photocurable composition comprising the following components (A)-(D):
(A) at least one of the (meth) acrylates having the structures shown by the formulas (1) and (2)(excluding the following component (C)), 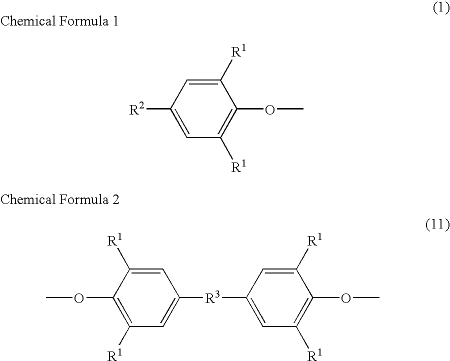
wherein R′ represents a hydrogen atom or a halogen atom excluding a fluorine atom, R² is a hydrogen atom, a halogen atom excluding a fluorine atom, Ph-C(CH₃)₂—, Ph-, or an alkyl group having 1-20 carbon atoms, and R³ represents —CH₂—, —S—, or —C (CH₃)₂—,
(B) a (meth)acrylate having three or more functional groups,
(C) a monofunctional monomer of which the homopolymer has a Tg of 150° C. or more, and
(D) a radical photoinitiator, wherein 5-50 wt % of the total acrylic components in the composition is a methacrylate compound and the component (C) is contained in an amount of 4-40 wt %.

2. The photocurable composition according to claim 1, wherein a monomer of which the homopolymer has a Tg of 35° C. or less is not contained as an acrylic component other than the component (A) and the component (B).

3. The photocurable composition according to claim 1, wherein the refractive index of the cured product is 1.55 or more at 25° C.

4. The photocurable composition according to claim 1, wherein the softening point of the cured product of the composition is 40° C. or more.

5. The photocurable composition according to claim 1, which is used for forming an optical part.

6. An optical part obtained by curing the photocurable composition according to claim 5.
